(19) United States
(12) Patent Application Publication
(10) Pub. No.: US 2024/0369294 A1
(43) Pub. Date: Nov. 7, 2024

(54) LIQUEFIED NATURAL GAS PRODUCTION UNIT AND START-UP METHOD OF A LIQUEFIED NATURAL GAS PRODUCTION UNIT TO MINIMIZE STORAGE CONTAMINATION

(71) Applicant: NUOVO PIGNONE TECNOLOGIE - SRL, Florence (IT)

(72) Inventor: Olaf STALLMANN, Frankfurt (DE)

(21) Appl. No.: 18/557,533

(22) PCT Filed: Apr. 21, 2022
(86) PCT No.: PCT/EP2022/025167

§ 371 Date: Oct. 26, 2023

(30) Foreign Application Priority Data
Apr. 26, 2021 (IT) 102021000010457

(51) Int. Cl. F25J 1/02; F25J 1/00

(52) U.S. Cl. CPC F25J 1/0212; F25J 1/0022; F25J 1/0247; F25J 2220/64

(57) ABSTRACT

A liquefied natural gas production unit and a method of managing the same, the unit comprising a cold box providing a plurality of heat exchangers configured to cool down natural gas, a separator configured to separate pre-cooled natural gas into a vapor stream and a heavy hydrocarbon liquid stream, a debutanizer connected to the bottom of the separator through a heavy hydrocarbon liquid stream line, the debutanizer being configured to evaporate light hydrocarbons from the heavy hydrocarbon liquid stream, a liquid stream line connected to the bottom of the debutanizer, a vapor stream line connecting the top of the separator with the cold box, and a light hydrocarbons vapor line connecting the top of the debutanizer with the cold box, a natural gas line collecting the natural gas from the vapor stream line and from light hydrocarbons vapor line downstream the cold box.

### TECHNICAL FIELD

The present disclosure concerns a liquefied natural gas production unit and a method of operating a liquefied natural gas production unit. Embodiments disclosed herein specifically concern a method of operating a liquefied natural gas production unit during start-ups, wherein components of the unit are provisionally used according to operating steps aiming to minimize the amount of liquefied natural gas with an off-spec composition.

### BACKGROUND ART

Natural gas is a naturally occurring hydrocarbon gas mixture comprising primarily of methane, but commonly including little amounts of other hydrocarbons, mainly light alkenes like propane and butane.

For practical and commercially viable transport of natural gas, its volume has to be greatly reduced. To do this, the gas must be liquefied by refrigeration to less than −161° C. (the boiling point of methane at atmospheric pressure). Each liquid natural gas production plant consists of one or more liquefaction and purification facilities to convert natural gas into liquefied natural gas.

The liquefaction process involves removal of certain components, such as dust, acid gases, water, mercury and heavy hydrocarbons, which could cause difficulty downstream. The natural gas is then condensed into a liquid with a vapor pressure close to atmospheric pressure by cooling it to approximately −162° C.; maximum transport pressure is set at around 25 kPa (4 psi).

In order to reduce the temperature of natural gas, the heat of the natural gas is transferred to a refrigerant fluid in controlled conditions through the use of heat exchangers. After having absorbed heat from the natural gas, in order to be reused the refrigerant fluid is conveniently cooled in a closed thermodynamic refrigeration cycle, wherein a cooling effect is produced through cyclic thermodynamic transformations, including compression, cooling, condensation, expansion and vaporization.

In order to obtain the liquefaction of natural gas through heat exchange with a refrigerant fluid, efficiency of heat exchange is a key issue in order to save costs. To this aim, the components of the liquid natural gas production unit are carefully designed.

An important solution to increase the efficiency of heat exchange is the use of the so-called cold boxes. A cold box is a complete package of brazed aluminum heat exchangers contained in a casing with structural support, thermal insulation containment, and protection for the internal equipment. The thermal insulation of heat exchangers and piping can be obtained in a single casing, making use of a common insulation, for example by using insulating materials inside the casing and by pressurizing and purging through dry nitrogen gas.

Cold boxes allow very compact layout and offer a highly efficient thermal insulation, without maintenance needed, to the heat exchange between natural gas and refrigerant fluid. Additionally, on-site installation work is very limited and access to connection piping is simple due to an optimized design, making construction a very quick and simple step and reducing pre-commissioning.

During start-up of the liquefied natural gas production unit, in order to reach the temperature needed to liquefy the natural gas according to the specifications, the cold box needs to be cooled down. This cooling down of the cold box is obtained through the same refrigerant fluid used to exchange heat with the natural gas. Cooling down rate is limited to avoid high thermal stress inside the brazed aluminum heat exchanger that could cause defects to the exchanger integrity. Despite the fact that initially the refrigerant temperature is not yet sufficient to obtain a liquefied natural gas according to the specifications, nevertheless, usually, also during the cooling down of the cold box a small flow of natural gas is routed over the cold box to ensure a homogenous temperature profile inside the cold box core and allow better control of the cool-down rate. As a consequence, during the cooling down of the cold box a liquefied natural gas is obtained having a composition that does not comply with the specifications, because the separation of heavy hydrocarbons obtained is not sufficient.

According to the prior art several options exist. In case the off-spec partly liquefied natural gas is routed to the normal storage tank, heavy hydrocarbons accumulate in the storage tank and cause the need for periodic cleaning.

In order to limit this problem, always according to the prior art, partly liquid liquefied natural gas can be routed to a flare. If the flare drum is not big enough, it could be overfilled, causing safety risks that usually result in plant shut-down. Therefore, this solution is only possible when the flare drum features a sufficiently big evaporator or in case a dedicated evaporator must be realized, which increases the costs of the plant.

Another solution is operating the start-up without routing any natural gas flow over the cold-box. This approach can cause high temperature rates of change even at minimal control fluctuations from missing moderation, which could result in possible damages of the equipment. Furthermore, it would exclude the pre-cooled gas separator from the cool-down process causing an adverse reheat effect once the NG flow is started.

Therefore, possible solutions according to the prior art either negatively affects the installation costs of the system or may have an adverse impact on overall safety of the plant.

Accordingly, an optimized management of a liquefied natural gas production unit with the aim of addressing the issues related to the production of liquefied natural gas that does not comply with the specifications during start-up of the unit would be beneficial and would be welcomed in the technology. More in particular, it would be desirable to provide an optimized management of a liquefied natural gas production unit during start-ups adapted to more efficiently address problems entailed by the production of off spec liquefied natural gas due to incomplete cooling down of the cold box.

### SUMMARY

In one aspect, the subject matter disclosed herein is directed to a liquefied natural gas production unit comprising a cold box, a separator configured to separate pre-cooled natural gas into a vapor stream and a heavy hydrocarbon liquid stream, a debutanizer configured to provide heat to the heavy hydrocarbon liquid stream in order to evaporate light hydrocarbons, the vapor stream from the top of the separator and the light hydrocarbons vapor from the top of the debutanizer being further cooled by the cold box and being collected downstream the cold box in a natural gas line, the liquefied natural gas production unit comprising a line connecting the natural gas line to the debutanizer and an auxiliary vapor line connecting the debutanizer to a utility system.

In another aspect, the subject matter disclosed herein concerns a method of managing a liquefied natural gas production unit during start-ups, the method comprising the step of routing the off spec natural gas stream from the cold box to the debutanizer, to be evaporated and subsequently sent to a utility system, such as a flare, a fuel gas unit or a boil-off gas system.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a process flow diagram of a liquefied natural gas production unit according to the prior art; and

FIG. 2 illustrates a process flow diagram of an optimized liquefied natural gas production unit, according to an exemplary embodiment.

### DETAILED DESCRIPTION OF EMBODIMENTS

According to the prior art, a liquefied natural gas production unit comprises a cold box 10, a separator 20, a debutanizer 30 and a flare drum separator 40. The cold box 10 comprises a plurality of heat exchangers, represented as a whole as a main heat exchanger 11, for thermal exchange between the process streams of the liquefied natural gas production unit and a refrigerant fluid. According to an exemplary refrigeration technology of the prior art, the refrigerant fluid can be conveniently composed of two or more components, and is consequently named a “mixed refrigerant”, is cooled in a closed thermodynamic refrigeration cycle system 50, wherein a cooling effect is produced through cyclic thermodynamic transformations of the refrigerant fluid, including compression, cooling, condensation, expansion and vaporization.

Making reference to the figures, according to an exemplary refrigeration technology of the prior art that can also be used in the liquefied natural gas production unit of the invention, the refrigerant fluid from a collector 51 is compressed in a first compressor 52 and subsequently cooled in a first heat exchanger 53, wherein the heaviest fractions of the refrigerant condense. The cooled refrigerant stream is then routed to a first separator 54, wherein it is separated into a liquid stream and a vapor stream. The liquid stream is directed via a liquid stream line 55 to the main heat exchanger 11 of the cold box 10, wherein it absorbs heat and is partly vaporized. The partly vaporized stream is then sent to a separator 12 of the cold box 10, wherein it is separated into a liquid stream and a vapor stream. Both the liquid stream and the vapor stream from the separator 12 are routed to the main heat exchanger 11 of the cold box 10, respectively via a liquid stream line 13 and a vapor stream line 14, to absorb heat before being directed to a collector 51 of the closed thermodynamic refrigeration cycle system 50.

The vapor stream from the first separator 54 of the closed thermodynamic refrigeration cycle system 50 is sent via a vapor stream line 56 to a second compressor 57 and subsequently cooled in a second heat exchanger 58 wherein other fractions of the refrigerant condense. The cooled refrigerant stream is then routed to a second separator 59, wherein it is separated into a liquid stream and a vapor stream, the vapor stream being composed of the lightest fractions of the refrigerant. The liquid stream is directed via a liquid stream line 60 to the main heat exchanger 11 of the cold box 10, wherein it absorbs heat and is partly vaporized. The partly vaporized stream is then sent to a separator 15 of the cold box 10, wherein it is separated into a liquid stream and a vapor stream. Both the liquid stream and the vapor stream are routed, respectively through a liquid stream line 16 and the vapor stream line 17, to the main heat exchanger 11 of the cold box 10, to absorb heat before being directed to the collector 51 of the closed thermodynamic refrigeration cycle system 50.

The vapor stream from the second separator 59 of the closed thermodynamic refrigeration cycle system 50 is directed via a vapor stream line 61 to the cold end of the main heat exchanger 11 of the cold box 10, wherein it is cooled and partly condensed. The partly condensed stream is then sent to a separator 18 of the cold box 10, wherein it is separated into a liquid stream and a vapor stream. Both the liquid stream and the vapor stream are routed, respectively via a liquid stream line 19 and the vapor stream line 191, to the main heat exchanger 11 of the cold box 10, to absorb heat before being directed to the collector 51 of the closed thermodynamic refrigeration cycle system 50.

The mixed refrigerant cycle allows to exchange heat with the natural gas in a plurality of heat exchangers at different temperatures, taking advantage of the vaporization temperature difference between the different generated refrigerant streams to optimize the natural gas liquefaction by approaching the cooling curve of the natural gas from ambient to cryogenic temperatures, minimizing energy requirements and heat exchangers size.

On the natural gas side of the liquefied natural gas production unit, under steady state conditions, a natural gas stream is routed via a natural gas stream line 1 to the main heat exchanger 11 of the cold box 10, to be pre-cooled in order to condense heavier than methane hydrocarbons. The pre-cooled natural gas stream is then routed to the separator 20, wherein it is separated into a liquid stream and a vapor stream, the liquid stream comprising heavier than methane hydrocarbons, together with a certain amount of methane. From the top of the separator 20, the vapor stream is routed via a vapor stream line 22 to the cold box 10, to be cooled at a temperature causing the condensation of the vapor.

The liquid stream comprising heavier than methane hydrocarbons is routed via a liquid stream line 21 to the debutanizer 30, to separate methane still present in the liquid stream, from heavier than methane hydrocarbons, in particular from butane. The debutanizer 30, being composed of a pressurized column with a boiler at its bottom, provides heat to the liquid stream, vaporizing the lighter components of the liquid stream, mainly methane with a little amount of propane and some butane, which run through the column wherein a vapor-liquid equilibrium is established between components with different boiling points. A liquid stream from the boiler of the debutanizer, comprised mainly of butane, but also comprising propane and heavier than butane components, is obtained and is routed via a liquid stream line 31 to a liquid petroleum gas collection unit 35. A vaporized stream from the top of the debutanizer 30, mainly comprising methane, is sent via a vaporized stream line 32 to the cold box 10, wherein it is condensed to form, together with the condensed vapor stream routed via the vapor stream line 22, a liquefied natural gas stream, sent via a condensed vapor stream line 33 to a liquefied natural gas stream collection unit 34.

During start-up of the above described liquefied natural gas production unit, the cold box 10 needs to be cooled down before reaching the set operating temperature. Usually, according to the prior art, during cooling-down of the cold box 10 a small flow of natural gas is nevertheless routed over the cold box 10 to ensure a homogenous temperature profiles inside the cold box core. However, until the very end of the cooling-down process, due to not enough cold temperature, the separation of heavy hydrocarbons from the natural gas stream does not take place and therefore the debutanizer 30 is normally not in operation. This results in the natural gas stream not separating in the separator 20 and being completely routed as a vapor stream via the vapor stream line 22, to the cold box 10. Initially, heat exchange in the cold box 10 is not sufficient to completely liquefy the vapor stream and this leads to a partly liquid stream that does not respect the specifications with regards to heavy hydrocarbons concentration. As a consequence, according to the prior art, the partly liquid stream, rather than being collected as a final product in the liquefied natural gas stream collection unit 34, is sent to a partly liquid stream line 331 to reach the flare drum 40, wherein it absorbs heat to be vaporized before being routed, as a vapor, via the vapor stream line 41, to a flare 42. This operation can only be performed when the flare drum 40 features an evaporator that has sufficient size, otherwise the flare drum could be overfilled causing safety risks that usually result in plant shut-down.

According to one aspect, the present subject matter is directed to a liquefied natural gas production unit comprising a cold box, a separator and a debutanizer configured to be able to be provisionally used, during start-ups, so to minimize the amount of liquefied natural gas with a composition that is not compliant with the specifications.

According to another aspect, the present subject matter is directed to a method of operating such a liquefied natural gas production unit.

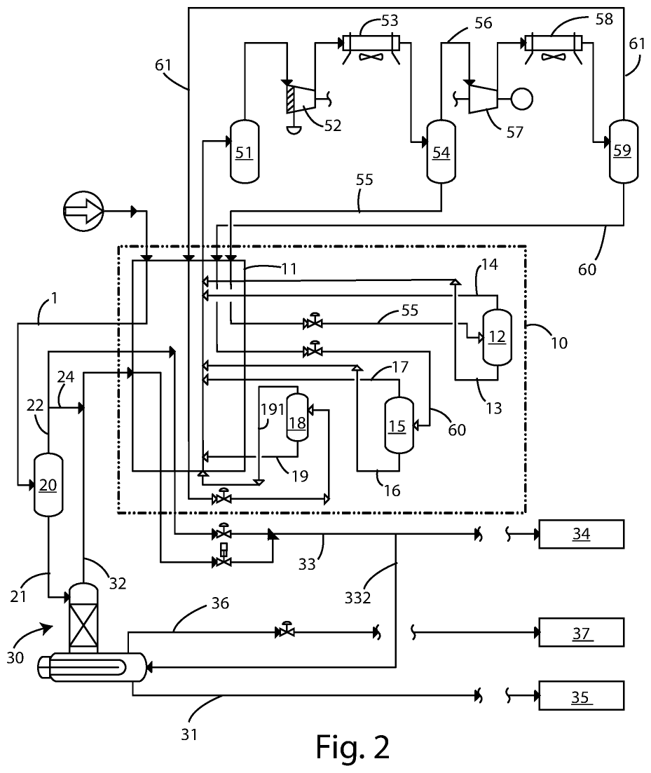

Reference now will be made in detail to one embodiments of the disclosure, which is illustrated in FIG. 2 by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments, the articles “a”, “an”, “the”, and “said” are intended to mean that there are one or more of the elements. The terms “comprising”, “including”, and “having” are intended to be inclusive and mean that there may be additional elements other than the listed elements.

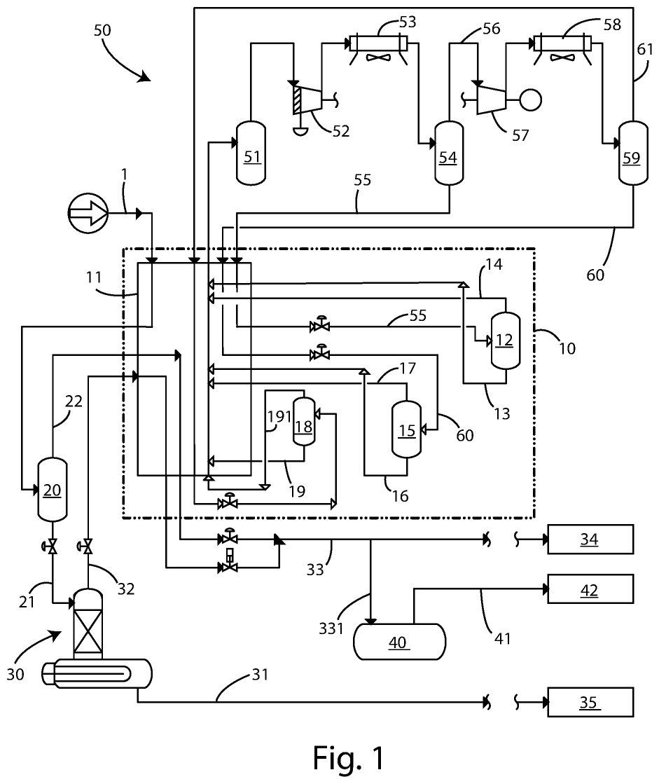

Referring now to FIG. 2, it is shown a process flow diagram of an exemplary optimized liquefied natural gas production unit from a natural gas stream. In steady state conditions, the liquefied natural gas production unit according to this exemplary embodiment operates as the liquefied natural gas production unit described with reference to FIG. 1. As a consequence, most of the components of the liquefied natural gas production unit according to this exemplary embodiment are the same as the components of the liquefied natural gas production unit described with reference to FIG. 1: these components will be indicated by the same numbers already used to describe the components of the liquefied natural gas production unit of FIG. 1 and will not be described again.

Differently from the liquefied natural gas production unit described with reference to FIG. 1, the liquefied natural gas production unit according to this exemplary embodiment does not comprise a flare drum 40 with evaporator, rather a line 332, to be used during start-ups of the production unit, connecting the line 33 from the cold box 10 to the boiler of the debutanizer 30. Additionally, the liquefied natural gas production unit according to this exemplary embodiment comprises a line 36 for collecting evaporated off spec natural gas from the debutanizer 30, alternatively to one of a flare 37, or to other utility systems like a fuel gas unit or boil-off gas system. Advantageously, the liquefied natural gas production unit according to this exemplary embodiment comprises a line 24, connecting the line 23 from the top of the evaporator 20 with the line 32 from the top of the debutanizer 30, as will be better explained in the following.

During start-ups of the above described liquefied natural gas production unit, as in the previously described liquefied natural gas production unit of FIG. 1, despite the fact that the cold box 10 is not at the set operating temperature, a small flow of natural gas is nevertheless routed over the cold box 10 to ensure a homogenous temperature profile inside the cold box core. The separation of heavy hydrocarbons from the natural gas stream does not take place and the natural gas stream does not condense in the separator 20 and is completely routed as a vapor via the vapor stream line 22 to the cold box 10. The line 21 from the separator 20 to the debutanizer 30 and the line 32 from the top of the debutanizer 30 to the cold box 10 are closed. Advantageously, part of the stream from the separator 20 to the cold box 10 via the vapor stream line 22 is routed to the line 32, via the line 24, to homogenize the temperature profile also in the corresponding part of the main heat exchanger 11 and so ensure a homogenous temperature profiles inside the whole cold box core. Initially, heat exchange in the cold box 10 is not sufficient to completely liquefy the vapor streams flowing into the lines 22 and 32, and after connection of the two lines, via the partly liquid stream line 33, and this leads to a partly liquid stream that does not respect the specifications with regards to heavy hydrocarbons concentration. As a consequence, according to this exemplary embodiment, the partly liquid stream, rather than being collected, is sent to the debutanizer 30, via a line 332, wherein it absorbs heat from the boiler of the debutanizer 30 to be vaporized before being routed, via a vapor stream line 36, to a flare 37. Alternatively, since the debutanizer 30 is a pressurized column, the evaporated off spec natural gas can be routed to other utility systems like a fuel gas unit or boil-off gas system and does not necessarily need to be sent to flare. This operation mode is maintained until the temperature of the pre-cooled stream of natural gas and the separator 20 has dropped low enough to cause condensation of heavy hydrocarbons and allows separation in the separator 20.

While aspects of the invention have been described in terms of various specific embodiments, it will be apparent to those of ordinary skill in the art that many modifications, changes, and omissions are possible without departing form the spirit and scope of the claims.

In particular, the kind of refrigeration fluid and refrigeration technology can be varied, important being the presence of at least one brazed aluminum heat exchanger, that could be damaged if it is not properly managed during cooling-down.

1. A liquefied natural gas production unit comprising:
a cold box, a separator configured to separate pre-cooled natural gas into a vapor stream and a heavy hydrocarbon liquid stream;
a debutanizer connected to the bottom of the separator through a heavy hydrocarbon liquid stream line, the debutanizer being configured to evaporate light hydrocarbons from the heavy hydrocarbon liquid stream, a liquid stream line being connected to the bottom of the debutanizer;
the top of the separator being connected to the cold box through a vapor stream line, and the top of the debutanizer being connected to the cold box through a light hydrocarbons vapor line, wherein the vapor stream line and the light hydrocarbons vapor line downstream the cold box are connected to the debutanizer through a line and wherein an auxiliary vapor line is connected to the debutanizer.

2. The liquefied natural gas production unit according to claim 1, wherein the vapor line is connected to one of a flare, a fuel gas unit or a boil-off gas system.

3. The liquefied natural gas production unit according to claim 1, wherein the vapor stream line is connected to the light hydrocarbons vapor line through a line.

4. A method of operating the liquefied natural gas production unit during start-ups, the liquefied natural gas production unit comprising a cold box, a separator configured to separate pre-cooled natural gas into a vapor stream and a heavy hydrocarbon liquid stream, a debutanizer connected to the bottom of the separator through a heavy hydrocarbon liquid stream line, the debutanizer being configured to evaporate light hydrocarbons from the heavy hydrocarbon liquid stream, a liquid stream line being connected to the bottom of the debutanizer, the top of the separator being connected to the cold box through a vapor stream line, and the top of the debutanizer being connected to the cold box through a light hydrocarbons vapor line, wherein the vapor stream line and the light hydrocarbons vapor line downstream the cold box are connected to the debutanizer through a line and wherein an auxiliary vapor line is connected to the debutanizer, the method comprising the steps of:
separating the debutanizer from the separator by closing the heavy hydrocarbon liquid stream line;
separating the top of the debutanizer from the cold box by closing the light hydrocarbons vapor line;
routing the natural gas stream from the cold box to the debutanizer by opening the line; and
collecting the vapor stream from the debutanizer by opening the auxiliary vapor line.

5. The method of claim 4, further comprising the step of:
splitting the vapor stream from the top of the separator between the vapor stream line and the light hydrocarbons vapor line, by opening the line.
